(19) United States
(12) Patent Application Publication
(10) Pub. No.: US 2018/0316936 A1
(43) Pub. Date: Nov. 1, 2018

(54) SYSTEM AND METHOD FOR DATA COMPRESSION

(71) Applicant: Newgen Software Technologies Limited, Chennai (IN)

(72) Inventors: Virender JEET, Noida (IN); Puja LAL, Delhi (IN); Abhishek JINDAL, Kurukshetra (IN); Prasad NEMMIKANTI, Khammam (IN); Sandeep BHATIA, Mandi (IN)

(73) Assignee: Newgen Software Technologies Limited, Chennai (IN)

(21) Appl. No.: 15/730,016

(22) Filed: Oct. 11, 2017

(30) Foreign Application Priority Data
Apr. 26, 2017 (IN) 201741014731

(51) Int. Cl. H04N 19/61; H04N 19/107; H04N 19/625; H04N 21/235; G06F 3/0482

(52) U.S. Cl. CPC H04N 19/61; H04N 19/107; G06F 3/0482; H04N 21/2353; H04N 19/625

(57) ABSTRACT

A system for compressing a plurality of data files is provided. The system includes a data receiver configured to receive a plurality of data files. Further, the system includes a data segregation module configured to identify a set of homogeneous files from the plurality of data files. The homogeneous file includes of a static region and a dynamic region. Further, the system includes a compression engine configured to compress the set of homogeneous files into a compressed video data file using a video compression technique. Furthermore, the system may include a storage module, configured to store the compressed video data file and associated meta data. A method and a tool for compressing a plurality of data files are also provided.

### PRIORITY STATEMENT

The present application hereby claims priority under 35 U.S.C. § 119 to Indian patent application number 201741014731 filed 26 Apr. 2017, the entire contents of which are hereby incorporated herein by reference.

Embodiments of the invention relate generally to data compression systems and more particularly to a system and method for compressing data files effectively using video compression technique.

### BACKGROUND

Various data processing applications are used across business organizations to capture and store data. Among such data sets, structured forms are extensively used and thereby stored in a compressed format. Structured forms are static forms that have defined page layouts for which templates can be built. Examples of structured forms include application forms, registration forms, receipts, cheques and the like. Storing such structured forms require large amount of resources. One way of reducing storage space is to compress the structured data files. Thus, compressing data (to be stored or transmitted) reduces the storage requirement as well as the communication cost.

Generally, data compression involves the process of encoding data using a representation in order to reduce the overall size of the data. In other words, data compression shrinks down a file so that it uses less storage space. Moreover, smaller data files ensure faster data transfer, thus proving to be more desirable in data communication. Data compression has an important application in the areas of data transmission and data storage.

Currently, various compression algorithms are used depending upon the nature of the data to be compressed. For example, data sets consisting of text and images are compressed using text compression and JPEG encoding. Typically, the objective of such compression techniques is to reduce data redundancy and store and/or transmit data in an efficient form. However, compression algorithms such as JPEG compression are effective when performed on a single image/file.

With large batches of structured forms, standard compressions techniques are not found to be effective. Therefore, there is a need for a compression technique that can effectively and efficiently compress large sets of data.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description. Example embodiments provide a data compression system for compressing the plurality of data files.

Briefly, according to an example embodiment, a system for compressing a plurality of data files is provided. The system includes a data receiver configured to receive a plurality of data files. Further, the system includes a data segregation module configured to identify a set of homogeneous files from the plurality of data files. Each homogeneous file comprises of a static region and a dynamic region. Further, the system includes a compression engine configured to compress the set of homogeneous files into a compressed video data file using a video compression technique. Furthermore, the system also includes a storage module which is configured to store the compressed video data file and associated meta data.

According to another embodiment, a business-process tool configured to implement a plurality of functions within a business organization is provided. The business-process tool includes a user interface module configured to enable a user to initiate a compression activity for a plurality of data files. Further, the business-process tool includes a processing engine configured to compress the set of homogeneous files. The processing engine further includes a data receiver which is configured to receive a plurality of data files. In addition, the processing engine includes a data segregation module which is configured to identify a set of homogeneous files from the plurality of data files. Each homogeneous file comprises a static region and a dynamic region. Further, the processing engine includes a compression engine configured to compress the set of homogeneous files into a compressed video data file using a video compression technique. Furthermore, the processing engine includes a storage module which is configured to store the compressed video data file and associated meta data.

According to yet another embodiment, a method for compressing a plurality of data files is provided. The method comprises receiving a plurality of data files and identifying a set of homogeneous files from the plurality of data files by determining a recurring pattern in the plurality of data files. Each homogeneous file comprises a static region and a dynamic region. The method further comprises compressing the set of homogeneous files into a compressed video data file using a video compression technique. In addition, the method comprises storing the compressed video data file and associated metadata.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram of one embodiment of a data compression system configured to compress a set of data files, according to the aspects of the present technique;

FIG. 2A and FIG. 2B are examples of homogeneous files, according to the aspects of the present technique;

FIG. 3 is an example embodiment illustrating an identification and segregation of homogeneous files, according to the aspects of the present technique;

FIG. 4 is a flow diagram illustrating a process for compressing a set of homogeneous files, according to the aspects of the present technique; and

FIG. 5 is a block diagram of an embodiment of a computing device in which the modules of the data compression system, described herein, are implemented.

### DETAILED DESCRIPTION OF EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein.

Accordingly, while example embodiments are capable of various modifications and alternative forms, example embodiments are shown by way of example in the drawings and will herein be described in detail. It should be understood, however, that there is no intent to limit example embodiments to the particular forms disclosed. On the contrary, example embodiments are to cover all modifications, equivalents, and alternatives thereof. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. Inventive concepts may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of inventive concepts.

Spatial and functional relationships between elements (for example, between modules) are described using various terms, including “connected,” “engaged,” “interfaced,” and “coupled”. Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The systems described herein, may be realized by hardware elements, software elements and/or combinations thereof. For example, the devices and components illustrated in the example embodiments of inventive concepts may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A central processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one or more computer-readable storage media.

At least one example embodiment is generally directed to a system for compressing a set of data files. Example embodiments of the present technique provide a system and method for achieving an effective and high compression for data files consisting of text and image data using video compression technique.

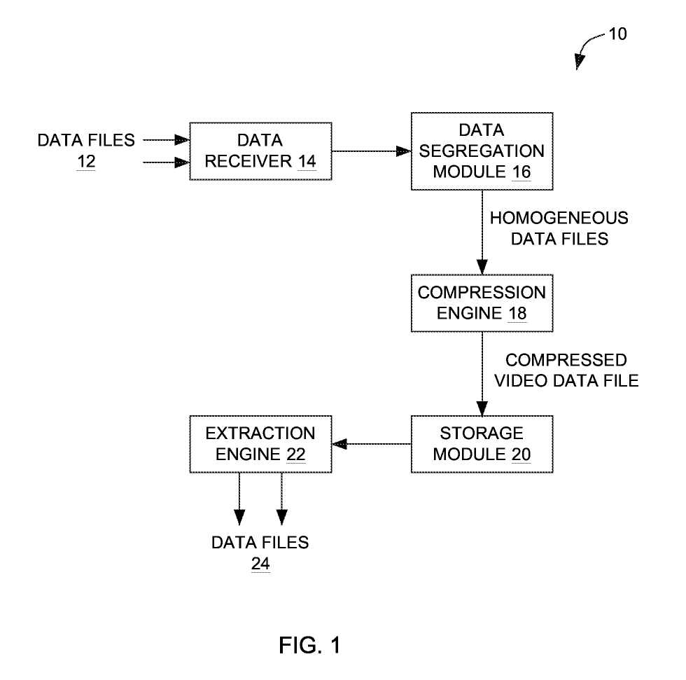

FIG. 1 is a block diagram of one embodiment of a data compression system for compressing a plurality of data files, according to the aspects of the present technique. The system 10 includes a data receiver 14, a data segregation module 16, a compression engine 18, a storage module 20 and an extraction engine 22. Each component is described in further detail below.

Data receiver 14 is configured to receive a plurality of data files 12 which are selected to be compressed. In one embodiment, the data files 12 are scanned in gray scale or color mode. In a further embodiment, the plurality of data files comprises images of a plurality of documents. Further, the data files are sent to the data segregation module 16.

Data segregation module 16 is configured to identify a set of homogeneous files from the plurality of data files. Such homogeneous files comprise of data arranged in a pre-defined structure. In an embodiment, each homogeneous file comprises a static region and a dynamic region. The static region in each homogeneous file comprises of fixed data and the dynamic region in each homogeneous file comprises of variable data. Various techniques such as template matching and logo matching may be used to identify the set of homogeneous files from the plurality of data files. In one embodiment, the homogeneous files are identified by determining a recurring pattern in each file.

Compression engine 18 is configured to receive the set of homogeneous files and compress the homogeneous files into a compressed video data file using a video compression technique. In an embodiment, the compression engine 18 is configured to use a video compression standard to generate the compressed video data file. In an example embodiment, MPEG-4 video compression is applied on each homogeneous file. Further, the identification numbers of compressed homogeneous files, such as a video identification number and frame identification number, are linked to corresponding meta data. Storage module 20 is configured to receive and store the compressed video data files and associated metadata.

Extraction engine 22 is configured to extract the plurality of data files from the compressed video data file and the metadata stored in the storage module. In one embodiment, the extraction engine 22 uses various extraction algorithms to extract the required data files. In an embodiment, the extraction algorithms operate on the generated compressed video data files to extract the original data file. In further embodiment, metadata is used to identify the exact frames and images. Such identified frames and images are retrieved for the final display of the original data file. As described above, a compressed video data file is generated for each set of homogeneous files. Examples of homogeneous files are described below.

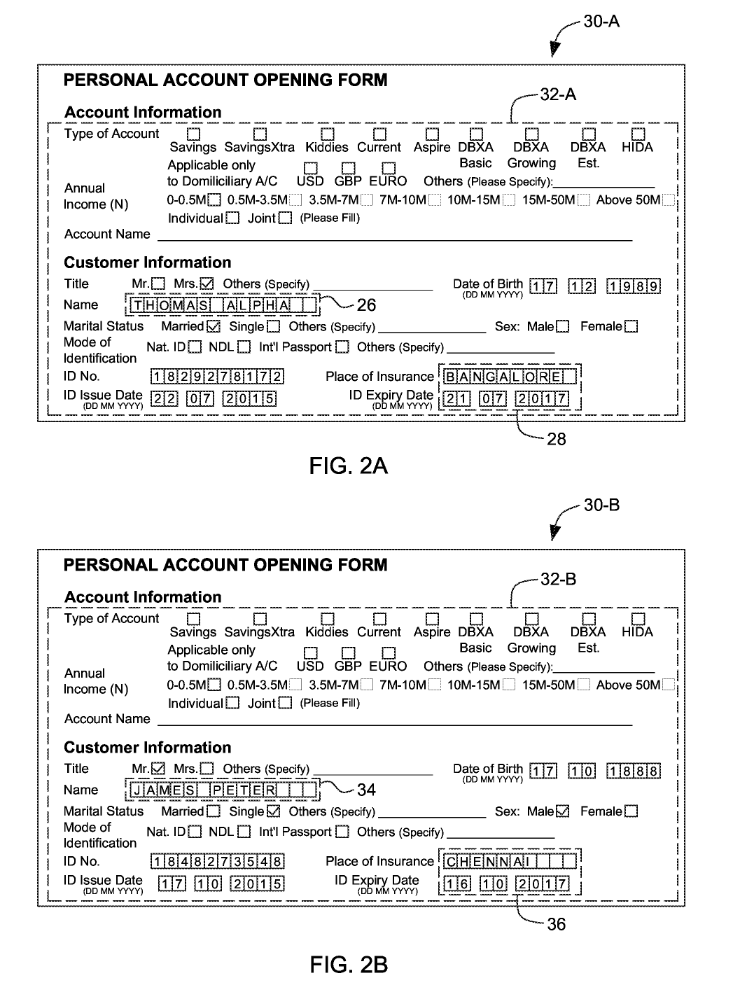

FIG. 2A and FIG. 2B are examples of homogeneous files, according to the aspects of the present technique. In the given example embodiments, the homogeneous files have a defined template and are personal account opening forms to be populated by corresponding users for an organizational enterprise. In these example embodiments, the “personal account opening forms” used by different users include the same attributes against which user details are to be filled. Such regions in the homogeneous file are identified as “static regions” as referred by reference numerals 32-A and 32-B in FIG. 2A and FIG. 2B.

In the given example embodiments, the “personal account opening forms” have been filled by two different users in FIG. 2A and FIG. 2B respectively. The filled up data regions include variable data. Such regions in the homogeneous data file are identified as “dynamic regions”. Examples of such regions are referred by reference numeral 26, 28, 34 and 38 in FIG. 2A and FIG. 2B. As can be seen, the homogeneous files 30-A and 30-B, have both static and dynamic regions. The manner in which the homogeneous files are identified and segregated from a plurality of data files are described in further detail below.

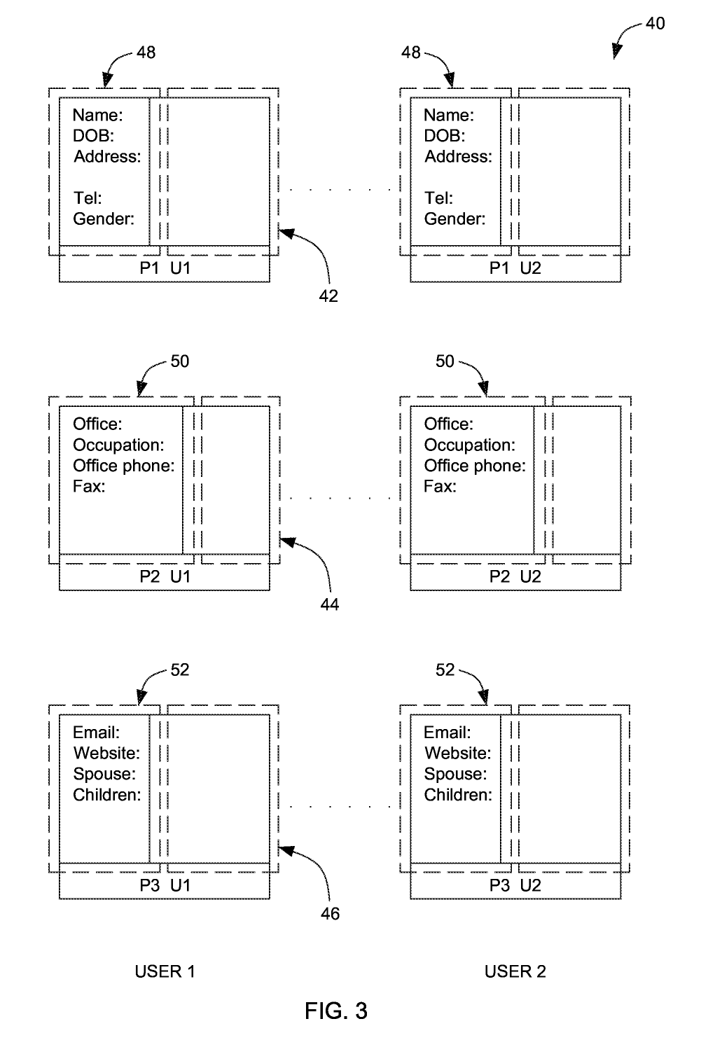

FIG. 3 is an example illustrating identification and segregation of homogeneous files, implemented according to aspects of the present invention. In this example, the homogeneous data files are user application forms submitted by different users associated with an organizational enterprise. Each application form consisting of three pages referenced by reference numerals P1, P2 and P3. For example, for 2 users, the total number of pages to be compressed will be 6. First page P1 of each user may include details such as Name, Date of birth, Address, Telephone and Gender. Similarly, second page P2 of each user may include details such as Designation, Office Address, Phone and Fax. Details such as Email, Website, Spouse and Children are obtained from third page P3 of the user application form.

In the illustrated example, it may be noted that page one of the application form for all users have the same attributes. Similarly, attributes of page two is the same across all users. Such data regions comprising fixed attributes are identified as static regions 48, 50 and 52. The user data to be filled against such homogeneous attributes is identified as dynamic regions as the data set will vary with each user. Examples of dynamic regions are referred by reference numerals 42, 44 and 46.

Assuming there are ‘n’ users in the above example, the total number of pages to compress is n*3. The first step in the process is to identify the homogeneous sets of documents. Clearly, page 1 of all users follow a fixed template. Similarly page 2 and page 3 follow a fixed template.

Thus, the first page of application form for all ‘n’ users correspond to a first set of homogeneous files. The first set of homogeneous files are compressed using a video compression technique to generate a first compressed video data file. Similarly, the second page for all ‘n’ users correspond to a second set of homogeneous files. The second set of homogeneous files are compressed using a video compression technique to generate a second compressed video data file. In one embodiment the level of compression achieved using the above technique is about 65%-75% more than using the standard JPEG compression techniques.

In one embodiment, an MPEG-4 compression technique is applied on the set of homogeneous files. MPEG-4 is a video compression standard, which uses the technique of spatial and temporal redundancy reduction. Spatial redundancy reduction may use a discrete cosine transform technique (DCT). In one embodiment, the DCT technique is used to transform the pixel values into the frequency space. In the above embodiment, some high frequency information can be discarded.

In further embodiment, reverse DCT is performed during the process of decoding and the discarded frequencies are not included in the generated image/file. In another embodiment, temporal redundancy technique may be used. Temporal redundancy technique encodes only the difference between successive frames instead of encoding each frame independently. In an embodiment, the temporal redundancy technique uses motion estimation to find the difference between the frames. For example, typically a video may be in the order of 20 to 30 frames per second and the successive frames in a video sequence may be very similar. In an embodiment, the difference in the successive frames is encoded for achieving video compression of the data files.

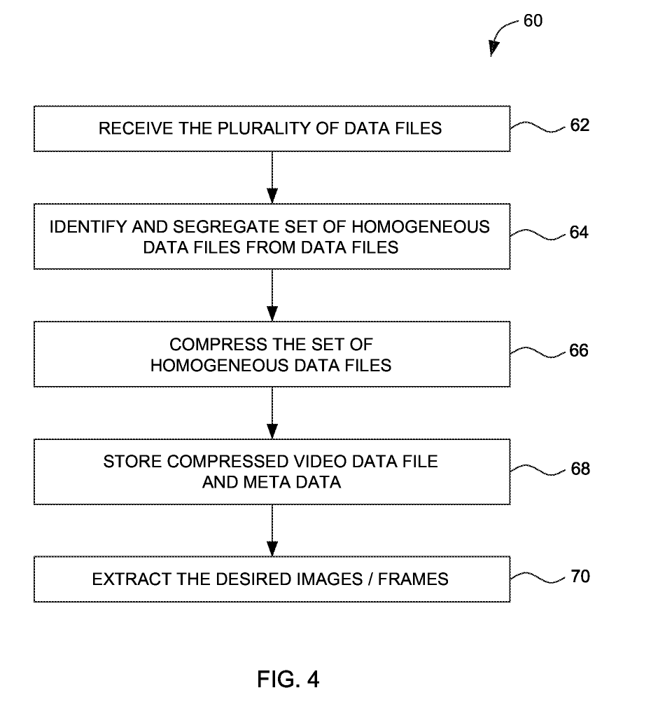

FIG. 4 is a flow diagram illustrating one method for compressing a set of homogeneous data files, according to the aspects of the present technique. As used herein, homogeneous data files refer to data files that follow a template. Each step is described in further detail below.

At step 62, a plurality of data files are received. The plurality of data files may be in the form of scanned images. In one embodiment, the plurality of data files include a set of homogeneous files and may also include non-homogeneous data files. Examples of homogeneous data files include application forms, registration forms, receipts, cheques and the like. It may be noted that homogeneous files have a recurring pattern.

At step 64, the set of homogeneous files are identified and further segregated from the plurality of data files. As described before, homogeneous files comprises data arranged in a pre-defined structure. Various techniques such as template matching and logo matching may be used to identify the set of homogeneous files from the plurality of data files. In one embodiment, the homogeneous files are identified by determining a recurring pattern in each file. In another embodiment, meta data is obtained for each homogeneous file. In addition, all the identified homogeneous files are brought to same resolution.

At step 66, the set of homogeneous files are compressed to generate a compressed video data file. In an embodiment, a video compression standard is used to generate the compressed video data file. In a specific embodiment, MPEG-4 video compression technique is used to generate the compressed video data file.

At step 68, the compressed video data files and associated metadata are stored in the storage module. Metadata may refer to the identification tags for video frames, etc.

At step 70, the required data files are extracted and recovered from the compressed data file using extraction algorithms. In an embodiment, the extraction algorithms may extract the plurality of data files from the compressed video data file and the meta data stored in the storage module. In further embodiment, metadata is used to identify the exact frames and images. Such identified frames and images are retrieved for the final display of the desired file/image.

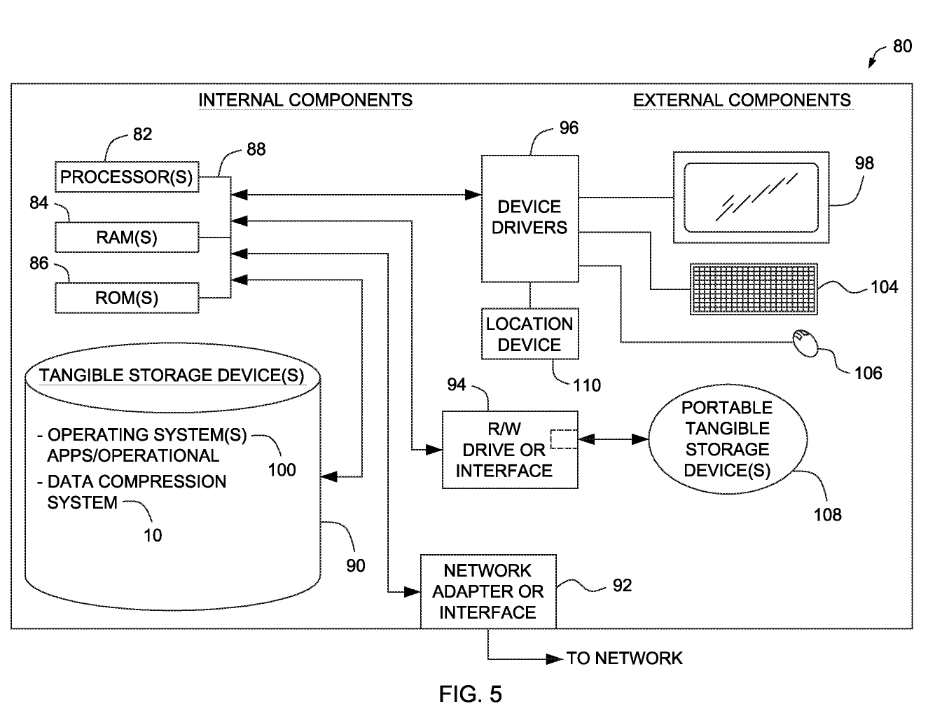

The modules of the data compression system 10 described herein are implemented in computing devices. One example of a computing device 80 is described below in FIG. 5. The computing device includes one or more processor 82, one or more computer-readable RAMs 84 and one or more computer-readable ROMs 86 on one or more buses 88. Further, computing device 80 includes a tangible storage device 90 that may be used to execute operating systems 100 and the data compression system 10. The various modules of the data compression system 10 including a data receiver 14, a data segregation module 16, a compression engine 18, a storage module 20 and an extraction engine 22 may be stored in tangible storage device 90. Both, the operating system 100 and the system 10 are executed by processor 82 via one or more respective RAMs 84 (which typically include cache memory). The execution of the operating system 100 and/or the system 10 by the processor 82, configures the processor 82 as a special purpose processor configured to carry out the functionalities of the operation system 100 and/or the data compression system 10, as described above.

Examples of storage devices 90 include semiconductor storage devices such as ROM 86, EPROM, flash memory or any other computer-readable tangible storage device that may store a computer program and digital information.

Computing device also includes a R/W drive or interface 94 to read from and write to one or more portable computer-readable tangible storage devices 108 such as a CD-ROM, DVD, memory stick or semiconductor storage device. Further, network adapters or interfaces 92 such as a TCP/IP adapter cards, wireless Wi-Fi interface cards, or 3G or 4G wireless interface cards or other wired or wireless communication links are also included in computing device.

In one example embodiment, the data compression system 10 which includes a data receiver 14, a data segregation module 16, a compression engine 18, a storage module 20 and an extraction engine 22, may be stored in tangible storage device 90 and may be downloaded from an external computer via a network (for example, the Internet, a local area network or other, wide area network) and network adapter or interface 92.

Computing device further includes device drivers 96 to interface with input and output devices. The input and output devices may include a computer display monitor 98, a keyboard 104, a keypad, a touch screen, a computer mouse 106, and/or some other suitable input device.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

1. A system for compressing a plurality of data files, the system comprising:
a data receiver configured to receive a plurality of data files;
a data segregation module configured to identify a set of homogeneous files from the plurality of data files; wherein each homogeneous file of the set of homogeneous files includes a static region and a dynamic region;
a compression engine configured to compress the set of homogeneous files and configured to generate a compressed video data file using a video compression technique.

2. The system of claim 1, further comprising a storage module configured to store the compressed video data file and associated metadata.

3. The system of claim 2, further comprising an extraction module configured to extract the plurality of data files from the compressed video data file and the metadata stored in the storage module.

4. The system of claim 1, wherein the video compression technique applies spatial and temporal redundancy reduction to generate the compressed video data file.

5. The system of claim 1, wherein the plurality of data files includes acquired images of documents.

6. The system of claim 1, wherein the set of homogeneous files are identifiable by determination of a recurring pattern in each file.

7. The system of claim 1, wherein the static region in each homogeneous file includes fixed data.

8. The system of claim 1, wherein the dynamic region in each homogeneous file includes variable data.

9. A tool for compressing a plurality of data files, the tool comprising:
a user interface configured to enable a user to initiate a compression activity for a plurality of data files;
a processing engine configured to compress the plurality of data files; the processing engine being further configured to:
receive the plurality of data files;
identify a set of homogeneous files from the plurality of data files; wherein each homogeneous file of the set of homogeneous files including a static region and a dynamic region; and
compress the set of homogeneous files to generate a compressed video data file using a video compression technique.

10. The tool of claim 9, wherein the set of homogeneous files are identifiable by determination of a recurring pattern in each file of the plurality of data files.

11. The tool of claim 9, wherein the static region in each homogeneous file includes fixed data and the dynamic region in each homogeneous file includes variable data.

12. The tool of claim 9, further comprising a memory, configured to store the compressed video data file and associated metadata, wherein the user interface is further configured to enable the user to extract the set of homogeneous files from the stored compressed data file and associated metadata.

13. A method for compressing a plurality of data files, the method comprising:
receiving a plurality of data files;
identifying a set of homogeneous files from the plurality of data files by determining a recurring pattern in the plurality of data files; and
compressing the set of homogeneous files to generate a compressed video data file using a video compression technique.

14. The method of claim 13, wherein each homogeneous file of the set of homogeneous files includes a static region and a dynamic region; and wherein the static region includes fixed data and the dynamic region, in each homogeneous file, includes variable data.

15. The method of claim 13, further comprising storing the compressed video data file and associated metadata.

16. The method of claim 15, further comprising extracting the set of homogeneous files from the stored compressed video data file and the metadata.

17. The method of claim 13, further comprising applying spatial and temporal redundancy reduction using the video compression technique to generate the compressed video data file.
